(19) United States
(12) Patent Application Publication
(10) Pub. No.: US 2016/0241036 A1
(43) Pub. Date: Aug. 18, 2016

(54) ENERGY APPARATUSES, ENERGY SYSTEMS, AND ENERGY MANAGEMENT METHODS INCLUDING ENERGY STORAGE

(71) Applicant: James F. Wolter, Spring Lake, MI (US)

(72) Inventor: James F. Wolter, Spring Lake, MI (US)

(21) Appl. No.: 15/135,688

(22) Filed: Apr. 22, 2016

Related U.S. Application Data
(63) Continuation-in-part of application No. 13/628,941, filed on Sep. 27, 2012.
Application No. 13/628,941 is a continuation-in-part of application No. 14/852,426, filed on Sep. 11, 2015.
Application No. 14/852,426 is a continuation-in-part of application No. 14/880,578, filed on Oct. 12, 2015.

(51) Int. Cl. H02J 3/28; G05B 15/02; H02J 3/38

(52) U.S. Cl. CPC H02J 3/28; H02J 3/383; H02J 3/386; H02J 3/387; H02J 3/382; G05B 15/02

(57) ABSTRACT

Energy apparatuses, energy systems, and energy management methods may include energy storage. More particularly, energy apparatuses, energy systems, and energy management methods may include at least one of: energy source health data, weather data, or energy load prioritization data. The energy apparatuses, energy systems, and energy management methods may automatically control flow of energy based on at least one of: energy source health data, weather data, or energy load prioritization data.

### CROSS REFERENCE TO RELATED APPLICATIONS

This application is a continuation-in-part of U.S. patent application Ser. No. 13/628,941, entitled POWER GENERATION SYSTEM WITH INTEGRATED RENEWABLE ENERGY GENERATION, ENERGY STORAGE, AND POWER CONTROL, filed Sep. 27, 2012; U.S. patent application Ser. No. 14/852,426, entitled DISTRIBUTED ENERGY STORAGE AND POWER QUALITY CONTROL IN PHOTOVOLTAIC ARRAYS, filed Sep. 11, 2015; and U.S. patent application Ser. No. 14/880,578, entitled SOLAR PANEL SYSTEM WITH MONOCOQUE SUPPORTING STRUCTURE, filed Oct. 12, 2015, the disclosures of which are incorporated in their entireties herein by reference thereto.

### TECHNICAL FIELD

The present disclosure relates generally to energy apparatuses, energy systems, and energy management methods. More particularly, the present disclosure relates to energy apparatuses, energy systems, and energy management methods that include energy storage.

### BACKGROUND

In the twentieth century, grid electrical power was largely generated by burning fossil fuel. When less power was required, less fuel was burned. Concerns with air pollution and global warming have spurned growth of intermittent renewable energy (e.g., solar power, wind power, etc.). Solar and wind power are generally uncontrolled, due to availability of sun or wind, respectively, and may only be available at a time when no additional power is needed by associated loads. Thus, interest in storing solar and wind generated power grows as the industry grows.

Furthermore, off-grid electrical use was a niche market in the twentieth century, however, in the twenty-first century, off-grid electrical use has expanded. For example, portable electrical generation devices are in use all over the world. Solar panels and wind turbines are now common sights in rural settings worldwide. Access to electricity is now a question of economics, not location.

Moreover, powering transportation (e.g., electric battery powered vehicles, hydrogen powered vehicles, etc.) without burning fuel in an internal combustion engine remains in development. Hybrid vehicles, having an internal combustion engine, electrical generation, electrical energy storage, and an electrical drive motor, are common place.

Modern-day energy supply systems may include centralized energy sources, distributed energy sources, or a combination of centralized energy sources and distributed energy sources. For example, energy may be provided to industrial, commercial, and/or residential facilities as a primary energy source (e.g., coal, raw oil, fuel oil, natural gas, wind, sun, streaming water, nuclear power, gasoline, geothermal, biomass, ethanol, biodiesel, ammonium, propane, wood, corn, legumes, synthetic fuels, etc.) or as a secondary energy source (e.g., electrical, hydrogen, liquefied natural gas, etc.). Secondary energy may be obtained through conversion of primary energy and may, for example, function as an energy carrier.

Furthermore, modern-day energy supply systems may also include energy storage, for example, electrochemical energy storage (e.g., flow battery, rechargeable battery, super-capacitor, Li capacitors, ultra-battery, etc.); electrical energy storage (e.g., capacitor, superconducting magnetic energy storage (SMES), etc.); mechanical energy storage (e.g., compressed air energy storage (CAES), fireless locomotive, flywheel energy storage, gravitational potential energy (device), hydraulic accumulator, liquid nitrogen, pumped-storage hydroelectricity, etc.); biological (e.g., glycogen, starch, etc.); thermal energy storage (e.g., brick storage heater, cryogenic liquid air or nitrogen, eutectic system, ice storage, molten salt, phase change material, seasonal thermal energy storage, solar pond, steam accumulator, geothermal, etc.); and chemical energy storage (e.g., biofuels, hydrated salts, hydrogen, hydrogen peroxide, power to gas, vanadium pentoxide, etc.).

As energy supply systems become more comprehensive, management of the associated energy apparatuses becomes more complex. Accordingly, improved energy apparatuses, energy systems, and energy management methods are needed.

Energy apparatuses, energy systems, and energy management methods may include primary energy sources, secondary energy sources, and/or energy storage. Energy supply systems may include centralized energy sources, distributed energy sources, a combination of centralized energy sources and distributed energy sources, and/or energy storage. For example, energy may be provided to industrial, commercial, and/or residential facilities as a primary energy source (e.g., coal, uranium-235 (²³⁵U), plutonium-239 (²³⁹Pu), plutonium-238 (²³⁸Pu), tritium (³H), raw oil, fuel oil, natural gas, wind, sun, streaming water, nuclear power, gasoline, geothermal, biomass, ethanol, biodiesel, ammonium, propane, wood, corn, legumes, etc.) or as a secondary energy source (e.g., electrical, hydrogen, liquefied natural gas, etc.). Secondary energy may be obtained through conversion of primary energy and may, for example, function as an energy carrier. Energy storage, may include electrochemical energy storage (e.g., flow battery, rechargeable battery, super-capacitor, ultra-battery, etc.); electrical energy storage (e.g., capacitor, superconducting magnetic energy storage (SMES), etc.); mechanical energy storage (e.g., compressed air energy storage (CAES), fireless locomotive, flywheel energy storage, gravitational potential energy (device), hydraulic accumulator, liquid nitrogen, pumped-storage hydroelectricity, etc.); biological (e.g., glycogen, starch, etc.); thermal energy storage (e.g., brick storage heater, cryogenic liquid air or nitrogen, eutectic system, ice storage, molten salt, phase change material, seasonal thermal energy storage, solar pond, steam accumulator, geothermal, etc.); and chemical energy storage (e.g., biofuels, synthetic fuels, hydrated salts, uranium-235 (²³⁵U), plutonium-239 (²³⁹Pu), plutonium-238 (²³⁸Pu), tritium (³H), hydrogen, hydrogen peroxide, power to gas, vanadium pentoxide, etc.).

Lead-acid batteries hold the largest market share of electric storage products. A single cell may produce two volts when fully charged. In the charged state, a metallic lead negative electrode and a lead sulfate positive electrode are immersed in a dilute sulfuric acid (H₂SO₄) electrolyte. In a discharge process electrons are pushed out of the cell as lead sulfate is formed at a negative electrode while the electrolyte is reduced to water.

A nickel-cadmium battery (NiCd) uses nickel oxide hydroxide and metallic cadmium as electrodes. Cadmium is a toxic element, and was banned for most uses by the European Union in 2004. Therefore, nickel-cadmium batteries have been almost completely replaced by nickel-metal hydride (NiMH) batteries.

The first commercial types of nickel-metal hydride (NiMH) batteries were available in 1989. NiMH batteries are now available in common consumer and industrial types. The NiMH battery typically includes an aqueous electrolyte along with a hydrogen-absorbing alloy for a negative electrode, instead of cadmium.

Lithium-ion batteries (e.g., lithium cobalt oxide (LiCoO₂), lithium iron phosphate (LiFePO₄), lithium ion manganese oxide battery (LMnO or LMO), lithium nickel cobalt aluminum oxide (LiNiCoAlO₂ or NCA), lithium titanate (Li₄Ti₅O₁₂ or LTO), and lithium nickel manganese cobalt oxide (LiNiMnCoO₂ or NMC)) offer low energy density, relatively long lives, and inherent safety. Such batteries are widely used for electric tools, medical equipment and other roles. NMC, in particular, is a leading contender for automotive applications. Lithium nickel cobalt aluminum oxide (LiNiCoAlO₂ or NCA) and lithium titanate (Li₄Ti₅O₁₂ or LTO) are used in many consumer electronics and have one of the best energy-to-mass ratios and a very slow self-discharge when not in use. Lithium-ion polymer batteries are similar.

### SUMMARY

An energy conversion apparatus may include at least one first reconfigurable energy source input. The at least one first reconfigurable energy source input may be reconfigurable based upon first energy source characteristic data received by the energy conversion apparatus. The energy conversion apparatus may also include at least one second reconfigurable energy source input. The at least one second reconfigurable energy source input may be reconfigurable based upon second energy source characteristic data received by the energy conversion apparatus. The energy conversion apparatus may further include at least one energy storage device connection and at least one energy load output. The energy conversion apparatus may be configured to provide energy to the at least one energy load output based upon the first and second energy source characteristic data, and further based on a quantity of energy stored in at least one energy storage device.

In another embodiment, an energy management system may include at least one energy conversion apparatus having at least two energy source inputs, at least one energy storage device connection, and at least one energy load output. The energy management system may also include a controller having at least one energy source health data input and at least one energy conversion apparatus output. The controller may generate the at least one energy conversion apparatus output based upon energy source health data received via the at least one energy source health data input.

In a further embodiment, an energy management system may include at least one energy conversion apparatus having at least one energy source input, at least one energy storage device connection, and at least two energy load outputs. The energy management system may also include a controller having at least one energy load priority data input and at least one energy conversion apparatus output. The controller may generate the at least one energy conversion apparatus output based upon energy load priority data received via the at least one energy load priority data input.

### BRIEF DESCRIPTION OF THE FIGURES

FIG. 1 depicts an example energy system including energy storage;

FIG. 2 depicts an example energy system including energy storage;

FIG. 3 depicts an example energy apparatus including energy storage;

FIG. 4A depicts an example apparatus for managing an energy apparatus including energy storage;

FIG. 4B depicts a flow diagram for an example method for managing an energy apparatus including energy storage;

FIG. 5A depicts an example apparatus for managing an energy apparatus including energy storage;

FIG. 5B depicts a flow diagram for an example method for managing an energy apparatus including energy storage;

FIG. 6A depicts an example apparatus for managing an energy system including energy storage;

FIG. 6B depicts a flow diagram for an example method for managing an energy system including energy storage;

FIG. 7A depicts an example apparatus for managing an energy system including energy storage;

FIG. 7B depicts a flow diagram for an example method for managing an energy system including energy storage;

FIG. 8A depicts an example apparatus for managing an energy apparatus including energy storage;

FIG. 8B depicts a flow diagram for an example method for managing an energy apparatus including energy storage;

FIGS. 9A and 9B depict an example energy apparatus;

FIG. 10A depicts an example apparatus for managing an energy apparatus as depicted in FIGS. 9A and 9B;

FIG. 10B depicts a flow diagram for an example method for managing an energy apparatus as depicted in FIGS. 9A and 9B.

### DETAILED DESCRIPTION

Energy apparatuses, systems, and methods of the present disclosure may include centralized energy sources, distributed energy sources, a combination of centralized energy sources and distributed energy sources, centralized energy storage, distributed energy storage, and/or a combination of centralized energy storage and distributed energy storage. For example, energy may be provided to industrial, commercial, and/or residential facilities as a primary energy source (e.g., coal, uranium-235 (²³⁵U), plutonium-239 (²³⁹Pu), plutonium-238 (²³⁸Pu), tritium (³H), raw oil, fuel oil, natural gas, wind, sun, streaming water, nuclear power, gasoline, geothermal, biomass, ethanol, biodiesel, ammonium, propane, wood, corn, legumes, synthetic fuels, etc.) or as a secondary energy source (e.g., electrical, hydrogen, liquefied natural gas, etc.). Secondary energy may be obtained through conversion of primary energy and may, for example, function as an energy carrier.

Energy storage may, for example, include electrochemical energy storage (e.g., flow battery, rechargeable battery, Li capacitors, super-capacitor, ultra-battery, etc.); electrical energy storage (e.g., capacitor, superconducting magnetic energy storage (SMES), etc.); mechanical energy storage (e.g., compressed air energy storage (CAES), fireless locomotive, flywheel energy storage, gravitational potential energy (device), hydraulic accumulator, liquid nitrogen, pumped-storage hydroelectricity, etc.); biological (e.g., glycogen, starch, etc.); thermal energy storage (e.g., brick storage heater, cryogenic liquid air or nitrogen, eutectic system, ice storage, molten salt, phase change material, seasonal thermal energy storage, solar pond, steam accumulator, geothermal, etc.); and chemical energy storage (e.g., biofuels, synthetic fuels, hydrated salts, hydrogen, hydrogen peroxide, power to gas, uranium-235 (²³⁵U), plutonium-239 (²³⁹Pu), plutonium-238 (²³⁸Pu), tritium (³H), vanadium pentoxide, etc.).

An energy storage device may include at least one lead-acid battery. A single cell of a lead-acid battery may produce, for example, two volts when fully charged. Alternatively, or additionally, an energy storage device may include at least one nickel-cadmium battery (NiCd) and/or at least one nickel-metal hydride (NiMH) battery. As another alternative, or addition, an energy storage device may include at least one lithium-ion battery (e.g., lithium cobalt oxide (LiCoO₂), lithium iron phosphate (LiFePO₄), lithium ion manganese oxide battery (LMnO or LMO), lithium nickel cobalt aluminum oxide (LiNiCoAlO₂ or NCA), lithium titanate (Li₄Ti₅O₁₂ or LTO), solid state lithium (Li) battery, and lithium nickel manganese cobalt oxide (LiNiMnCoO₂ or NMC)).

Energy apparatuses, systems, and methods of the present disclosure may determine commitment requirements for various energy sources. Similarly, the energy apparatuses, systems, and methods of the present disclosure may determine dispatch requirements of previously committed energy sources. The commitment and dispatch requirements may account for routine maintenance and/or health factors of various energy sources and/or system components.

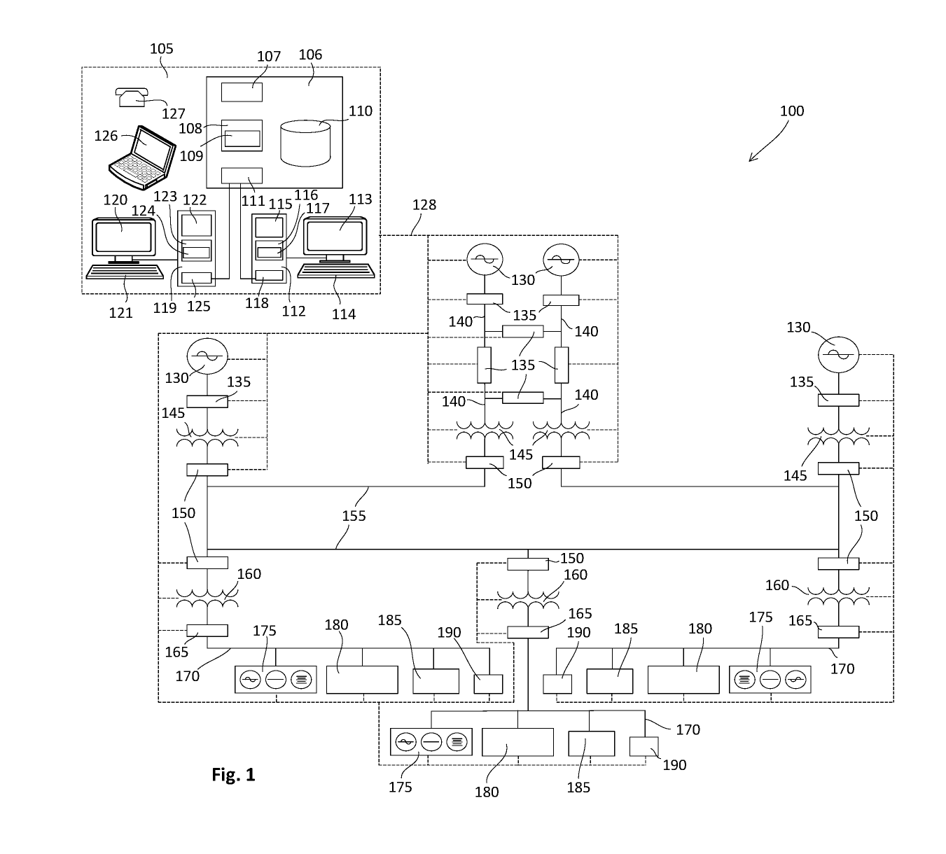

Turning to FIG. 1, an energy system 100 may include secondary energy sources 130 and distributed energy generation/energy storage devices 175. The energy system 100 may also include an energy management system 105 having a server 106, a first workstation 112, a second workstation 119, at least one portable computing device 126 (e.g., a laptop computer, a tablet, a PDA, a smartphone, etc.), and at least one voice communication device 127 (e.g., a telephone, a voice recognition device, etc.). The server 126 may include a first module 109 stored on a computer-readable memory 108 (e.g., a non-transitory computer-readable medium, a transitory computer-readable medium, etc.) that, when executed by a processor 107, causes the processor 107 to, for example, automatically control (e.g., commit and/or dispatch) various components (e.g., secondary energy sources 130, distributed energy generation/energy storage device 175, disconnect devices 135, 150, 165, etc.) of the energy system 100. While the first module 109 may include a set of computer-readable instructions, the first module 109 may alternatively be a hardware implementation of an equivalent electrical circuit. The server 106 may also include a communication network interface 111 to, for example, communicatively connect the server 106 to the first workstation 112, the second workstation 119, the portable computing device 126, the voice communication device 127, and/or the various components (e.g., secondary energy sources 130, distributed energy generation/energy storage device 175, disconnect devices 135, 150, 165 (e.g., fuse disconnects, switchgear, starters, manual disconnects, contactors, re-connection devices, circuit interrupters, valves, etc.), transformers 145, 160, industrial energy loads 180, commercial energy loads 185, residential energy loads 190, etc.) of the energy system 100 via a communication network 128.

The communication network 128 may include a hardwired link (e.g., a telephone line, an Ethernet connection, a coaxial line, etc.), a wireless link (e.g., a WiFi, a cellular telephone link, a local area network, a Bluetooth® link, et.), or a combination of various hardwired links and wireless links. Alternatively, or additionally, the communication network 128 may include at least one dedicated, proprietary, links (e.g., a secure network, etc.).

The energy system 100 and, in particular, the energy generation/energy storage device 175, may be as described in U.S. patent application Ser. No. 13/628,941, entitled POWER GENERATION SYSTEM WITH INTEGRATED RENEWABLE ENERGY GENERATION, ENERGY STORAGE, AND POWER CONTROL, filed Sep. 27, 2012; and U.S. patent application Ser. No. 14/852,426, entitled DISTRIBUTED ENERGY STORAGE AND POWER QUALITY CONTROL IN PHOTOVOLTAIC ARRAYS, filed Sep. 11, 2015, the disclosures of which are incorporated herein in their entireties by reference thereto.

Similarly, the first workstation 112 may include a second module 116 stored on a computer-readable memory 117 (e.g., a non-transitory computer-readable medium, a transitory computer-readable medium, etc.) that, when executed by a processor 115, causes the processor 115 to, for example, enable a user (e.g., an energy system operator, an engineer, an energy business manager, etc.) to monitor and/or control various components (e.g., secondary energy sources 130, distributed energy generation/energy storage device 175, disconnect devices 135, 150, 165, transformers 145, 160, industrial energy loads 180, commercial energy loads 185, residential energy loads 190, etc.) of the energy system 100. While the second module 116 may include a set of computer-readable instructions, the second module 116 may alternatively be a hardware implementation of an equivalent electrical circuit. The first workstation 112 may also include a display 113, a user input device 114, and a communication network interface 118 to, for example, communicatively connect the first workstation 112, the server 106, the second workstation 119, the portable computing device 126, the voice communication device 127, and/or the various components (e.g., secondary energy sources 130, distributed energy generation/energy storage device 175, disconnect devices 135, 150, 165, transformers 145, 160, industrial energy loads 180, commercial energy loads 185, residential energy loads 190, etc.) of the energy system 100 via a communication network 128.

Likewise, the second workstation 119 may include a third module 124 stored on a computer-readable memory 123 (e.g., a non-transitory computer-readable medium, a transitory computer-readable medium, etc.) that, when executed by a processor 122, causes the processor 122 to, for example, enable a user (e.g., an energy system operator, an engineer, an energy business manager, etc.) to monitor and/or control various components (e.g., secondary energy sources 130, distributed energy generation/energy storage device 175, disconnect devices 135, 150, 165, transformers 145, 160, industrial energy loads 180, commercial energy loads 185, residential energy loads 190, etc.) of the energy system 100. While the third module 124 may include a set of computer-readable instructions, the third module 124 may alternatively be a hardware implementation of an equivalent electrical circuit. The second workstation 119 may also include a display 120, a user input device 121, and a communication network interface 125 to, for example, communicatively connect the second workstation 119, the server 106, the first workstation 112, the portable computing device 126, the voice communication device 127, and/or the various components (e.g., secondary energy sources 130, distributed energy generation/energy storage device 175, disconnect devices 135, 150, 165, transformers 145, 160, industrial energy loads 180, commercial energy loads 185, residential energy loads 190, etc.) of the energy system 100 via a communication network 128.

A secondary energy source 130 may be, for example, an electrical generation device that may convert a primary energy source (e.g., coal, raw oil, fuel oil, natural gas, wind, sun, streaming water, nuclear power, gasoline, geothermal, biomass, ethanol, biodiesel, ammonium, propane, wood, corn, legumes, etc.) to electrical energy. Alternatively, or additionally, a secondary energy source 130 may include, for example, a hydrogen generator (e.g., a fuel cell), or a liquefied natural gas compressor. In any event, a primary energy source may be delivered to a secondary energy source 130 as needed and/or the primary energy source may be stored local to a respective secondary energy source 130. Notably, neither primary energy source delivery mechanisms nor primary energy source storage mechanisms are depicted in FIG. 1.

A secondary energy source 130 may generate, for example, direct current (DC) electrical energy or alternating current (AC) electrical energy having a first voltage (e.g., 120 volts, 240 volts, 480 volts, 600 volts, 1,000 volts, 4,160 volts, 13,200 volts, 33,000 volts, 66,000 volts, 132,000 volts, etc.). A secondary energy source 130 may be connected to at least one step-up transformer 145 via at least one generator disconnect device 135. A plurality of generator disconnect devices 135 may be arranged in a ring-bus configuration 140 to, for example, increase reliability and/or to facilitate maintenance activities. In any event, a step-up transformer 145 may transform the first voltage to a second voltage (e.g., 69,000 volts, 138,000 volts, 245,000 volts, 365,000 volts, 765,000 volts, 1,000,000 volts, etc.). An output side (e.g., the second voltage side) of a step-up transformer 145 may be connected to an energy transmission line 155 via, for example, at least one transmission disconnect device 150. Notably, an energy transmission line may extend hundreds, or thousands, of miles. As shown in FIG. 1, a transmission line may be connected in a “loop” configuration such that, for example, at least two paths may be provided for energy flow from any given secondary energy source 130 to any given energy load (e.g., industrial energy load 180, commercial energy load 185, residential energy load 190, distributed energy generation/energy storage device 175, etc.) to, for example, increase reliability and/or to facilitate maintenance activities.

A step-down transformer 160 may transform the second voltage (e.g., transmission voltage) to a third voltage (e.g., 4,160 volts, 13,200 volts, 32,000 volts, etc.). A step-down transformer 160 may be connected to an energy transmission line 155 via at least one transmission disconnect device 150 and connected to an energy distribution line 170 via at least one distribution disconnected 165. While not illustrated as such in FIG. 1, any given energy distribution line 170 may be connected in a “loop” such that energy may flow from at least one step-down transformer 160 to any given energy load (e.g., industrial energy load 180, commercial energy load 185, residential energy load 190, distributed energy generation/energy storage device 175, etc.) via at least two paths to, for example, increase reliability and/or to facilitate maintenance activities.

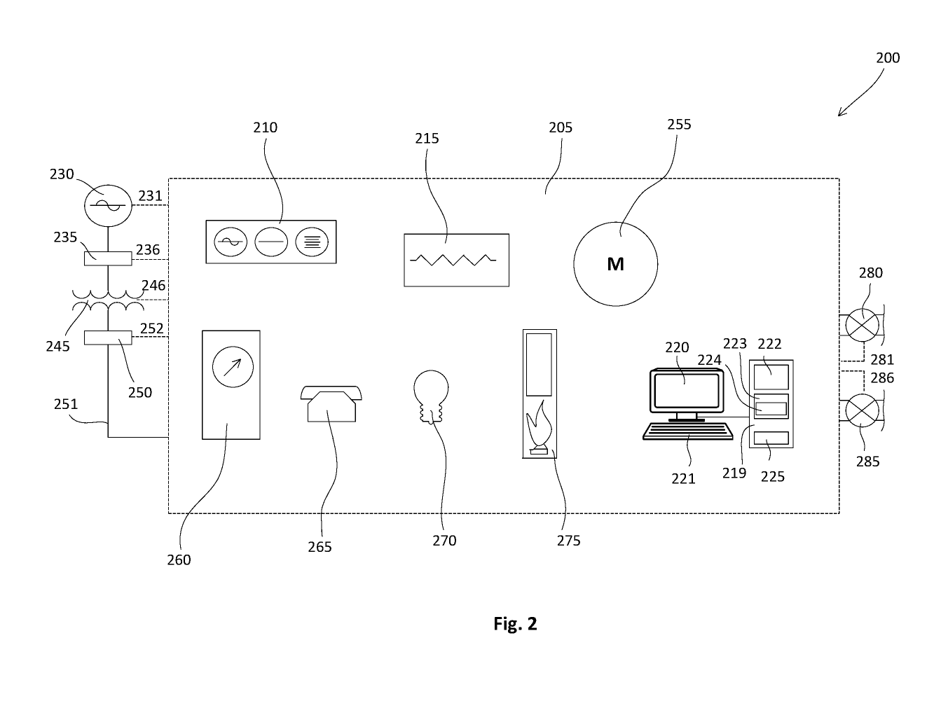

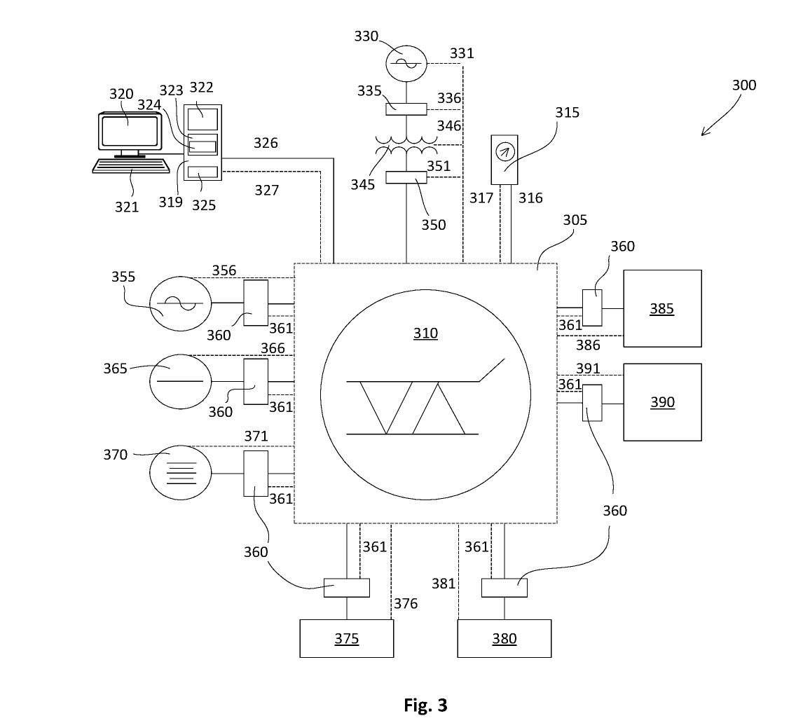

While not specifically indicated in FIG. 1, sensors (e.g., sensor 260 of FIG. 2 or sensor 315 of FIG. 3) may be included throughout the energy system 100 to, for example, measure and/or control various energy related values (e.g., energy measurement, electricity flow/volume, gas flow/volume, water flow/volume, mass flow/volume, etc.), and may be included at, or within, any one of the elements 130, 145, 150, 160, 165, 175, 180, 185, 190. Outputs of these metering devices may be incorporated with the energy management system 105 to provide additional monitoring and control functions, and/or to facilitate energy accounting and invoicing. The energy system 100 may include additional elements 130, 145, 150, 160, 165, 175, 180, 185, 190 at, or within, any one of the energy sources and/or energy loads to, for example, facilitate commitment and/or dispatch of any given energy source and to connect/disconnect any given load.

With reference to FIG. 2, an energy system 200 may include at least one energy load 205 (e.g., industrial energy load 180, commercial energy load 185, residential energy load 190, distributed energy generation/energy storage device 175, etc.). The energy system 200 may be similar to, for example, the energy system 100 of FIG. 1. The energy system 200 may include at least one energy generation/energy storage device 210, at least one resistive energy load 215 (e.g., a heating element, an igniter, etc.), at least one workstation 219, at least one secondary energy source 230, at least one rotating load (e.g., an electric motor, a steam driven motor, an internal combustion engine, etc.), at least one sensor 260 (e.g., an electric current sensor, a flow meter, a voltage sensor, a pressure sensor, a temperature sensor, a frequency sensor, a power factor sensor, a phase sequence sensor, a phase rotation sensor, a voltage waveform sensor, an oscilloscope, a strain gauge sensor, a rotation sensor, a linear sensor, a flow sensor, a proximity sensor, a watt-hour meter, a volume meter, etc.), a voice communication device 265, a light emitter 270 (e.g., an incandescent light, a light emitting diode, a fluorescent light, a high-pressure sodium light, a metal halide light, a mercury vapor light, etc.), an energy conversion device (e.g., a water heater, a boiler, a fuel cell, a furnace, an incinerator, a primary energy source burner, etc.), a first primary energy source 280, and a second primary energy source 285.

The secondary energy source 230 may be connected to the energy load 205 via an energy generation disconnect device 235, a step-up transformer 245, an energy transmission or energy distribution disconnect device 250, and an energy transmission or distribution line 251. The workstation 219 may include a module 224 stored on a computer-readable memory 223 (e.g., a non-transitory computer-readable medium, a transitory computer-readable medium, etc.) that, when executed by a processor 222, causes the processor 222 to, for example, enable a user (e.g., an energy system operator, an engineer, an energy business manager, etc.) to monitor and/or control various components (e.g., secondary energy source 230, distributed energy generation/energy storage device 210, disconnect devices 235, 250, transformer 245, resistive heat 215, motor 255, sensor 260, voice communication device 265, light source 270, energy conversion device 275, first primary energy source 280, second primary energy source 285, etc.) of the energy system 200. While the module 224 may include a set of computer-readable instructions, the module 224 may alternatively be a hardware implementation of an equivalent electrical circuit. The workstation 219 may also include a display 220, a user input device 221, and a communication network interface 225 to, for example, communicatively connect the workstation 219, the secondary energy source 230, the distributed energy generation/energy storage device 210, the disconnect devices 235, 250, the transformer 245, the resistive heat 215, motor 255, the sensor 260, the voice communication device 265, the light source 270, the energy conversion device 275, the first primary energy source 280, and the second primary energy source 285 of the energy system 100 via a communication network 231, 236, 246, 252, 281, 286.

While the first and second primary energy sources 280, 285 are illustrated as pipes/valves in FIG. 2, any given primary energy source may be stored in any suitable container (e.g., a tank, a hopper, a pile, a silo, a bunker, bulk storage, a vessel, a cave, a mine shaft, a tunnel, etc.) and may be conveyed via any suitable conveying device (e.g., a pipe/valve, a conveyor, an auger, a chute/gravity, a blower, etc.).

Turning to FIG. 3, an energy system 300 may include an energy conversion apparatus 305 (e.g., at least one fuel cell, at least one composter, at least one incinerator, at least one boiler, at least one burner, any combination thereof, etc.) that may convert a primary energy source to a secondary energy source. The energy system 300 may be similar to, for example, either the energy system 100 of FIG. 1 or the energy system 200 of FIG. 2. The energy conversion apparatus 305 may be a bidirectional devise that, for example, converts a primary energy source 385, 395 to a secondary energy source 330, 355, 365 and/or that converts a secondary energy source 330, 355, 365 to a primary energy source 385, 390.

The energy conversion apparatus 305 may include at least one energy conversion device 310 (e.g., AC-to-DC rectifier, at least one DC-to-AC inverter, at least on DC-to-DC converter, any combination thereof, etc.). The energy conversion device 310 may be bidirectional. For example, the energy conversion device 310 may rectify an AC electrical output of a secondary energy source (e.g., electrical generator 330, 355) to a DC energy storage device 370 input and may subsequently invert a DC energy output of the storage device 370 to an AC electrical supply to a load (e.g., electrical load 375, 380). Accordingly, a secondary energy source 330, 355 may generate energy using a primary energy source 385, 390, may store the energy in an energy storage device 370 (e.g., a battery, capacitor, etc.) and, subsequently, the energy conversion device 310 may extract energy from the energy storage device 370 to serve a load 375, 380.

The energy system 300 may further include at least one sensor 315 (e.g., an electric current sensor, a flow meter, a voltage sensor, a pressure sensor, a temperature sensor, a frequency sensor, a power factor sensor, a phase sequence sensor, a phase rotation sensor, a voltage waveform sensor, an oscilloscope, a strain gauge sensor, a rotation sensor, a linear sensor, a flow sensor, a proximity sensor, a watt-hour meter, a volume meter, etc.), at least one generation disconnect device 335, at least one step-up transformer 345, at least one energy transmission disconnect device 350, at least one energy distribution disconnect device 360, and at least one workstation 319. The workstation 319 may include a module 324 stored on a computer-readable memory 323 (e.g., a non-transitory computer-readable medium, a transitory computer-readable medium, etc.) that, when executed by a processor 322, causes the processor 322 to, for example, enable a user (e.g., an energy system operator, an engineer, an energy business manager, etc.) to monitor and/or control various components (e.g., sensor 315, secondary energy source 330, 365, energy storage device 370, disconnect devices 335, 350, 360, transformer 345, first primary energy source 385, second primary energy source 390, first energy load 375, second energy load 380, etc.) of the energy system 300. While the module 324 may include a set of computer-readable instructions, the module 324 may alternatively be a hardware implementation of an equivalent electrical circuit. The workstation 319 may also include a display 320, a user input device 321, and a communication network interface 325 to, for example, communicatively connect the workstation 319, the sensor 315, the secondary energy source 330, 365, the energy storage device 370, the disconnect devices 335, 350, 360, transformer 345, the first primary energy source 385, the second primary energy source 390, the first energy load 375, the second energy load 380 of the energy system 100 via a communication network 326, 327, 331, 336, 346, 351, 316, 317, 356, 361, 366, 371, 376, 381.

The workstation 319 may synchronize any given energy source to the energy system 300 based on frequency, power factor, inrush, transients, etc. For example, when any given energy source (e.g., primary energy source 280, 285 of FIG. 2, or secondary energy source 130, 175 of FIG. 1) is to be connected to the energy system 300, the workstation may acquire various inputs from sensors (e.g., sensor 260 of FIG. 2 or sensor 315 of FIG. 3), and may gradually increase energy output from the given energy source. Thereby, an energy customer may be billed for energy consumed and/or given credit for energy generated.

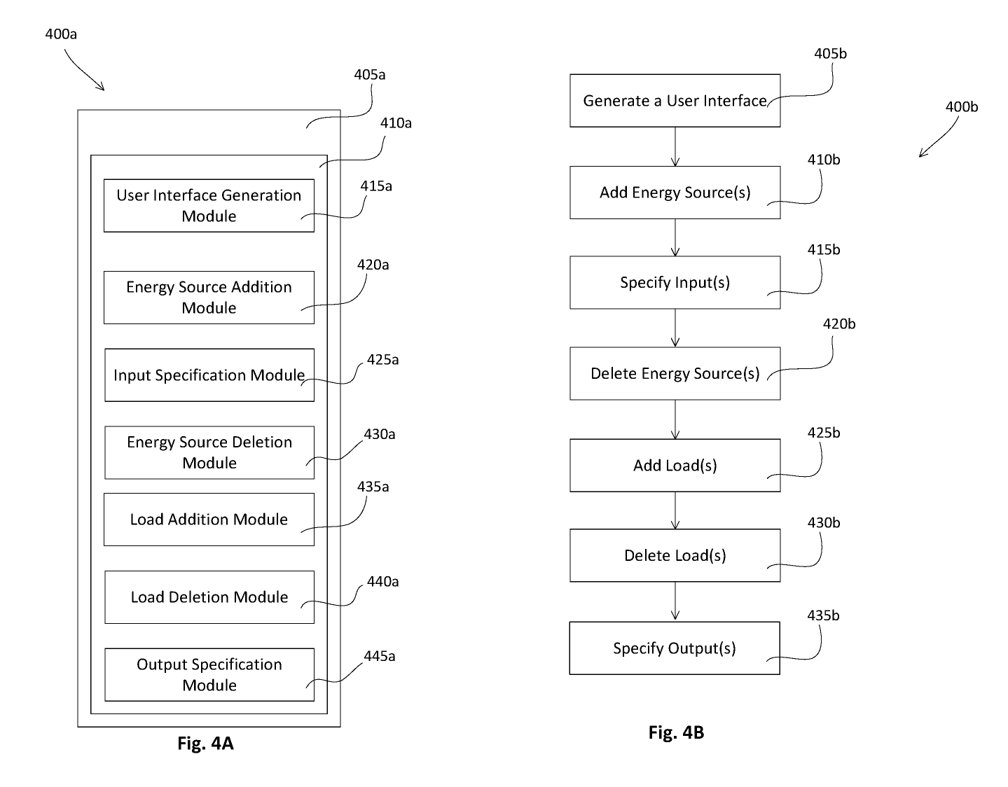

With reference to FIG. 4A, an apparatus 405a for managing an energy device 400a may include a user interface generation module 415a, an energy source addition module 420a, an input specification module 425a, an energy source deletion module 430a, a load addition module 435a, a load deletion module 440a, and an output specification module 445a stored on a memory 410a. The apparatus 405a may be similar to, for example, the workstation 319 of FIG. 3. The energy device 400a may be similar to, for example, the energy conversion device 305 of FIG. 3.

While the user interface generation module 415a, the energy source addition module 420a, the input specification module 425a, the energy source deletion module 430a, the load addition module 435a, the load deletion module 440a, or the output specification module 445a may be stored on the non-transitory computer-readable medium 410a in the form of computer-readable instructions, any one of, all of, or any sub-combination of the user interface generation module 415a, the energy source addition module 420a, the input specification module 425a, the energy source deletion module 430a, the load addition module 435a, the load deletion module 440a, or the output specification module 445a may be implemented by hardware (e.g., one or more discrete component circuits, one or more application specific integrated circuits (ASICs), etc.), firmware (e.g., one or more programmable application specific integrated circuits (ASICs), one or more programmable logic devices (PLDs), one or more field programmable logic devices (FPLD), one or more field programmable gate arrays (FPGAs), etc.), and/or any combination of hardware, software and/or firmware. Furthermore, the apparatus 405a of FIG. 4A may include one or more elements, processes and/or devices in addition to, or instead of, those illustrated in FIG. 4A, and/or may include more than one of, any, or all of the illustrated elements, processes and devices.

Turning to FIG. 4B, a method for managing an energy apparatus 400b may be implemented by, for example, a processor (e.g., processor 322 of FIG. 3) executing a module (e.g., module 324 of FIG. 3, or modules 415a-445a of FIG. 4A). In any event, the processor 322 may execute a user interface generation module 415a to, for example, cause the processor 322 to generate a user interface (block 405b). The user interface may enable a user to configure an energy device (e.g., energy conversion device 305 of FIG. 3). For example, a user may add an energy source (e.g., a primary energy source, a secondary energy source, an energy storage device, etc.), may specify associated inputs to the energy conversion device 305, may delete an energy source, may add a load (e.g., any of the loads described with regard to FIGS. 1-3), delete a load, or specify associated outputs of the energy conversion device 305. Alternatively, or additionally, the processor 322 may execute the user interface generation module 415a to, for example, cause the processor 322 to automatically configure the energy conversion device 305 any time an energy source and/or load is added and/or deleted.

The processor 322 may execute an energy source addition module 420a to, for example, cause the processor 322 to automatically add an energy source when an energy source is connected to the energy conversion device 305 (block 410b). Thereby, an energy conversion device 305 may automatically incorporate a newly connected energy source in accordance with a “plug-and-play” architecture. For example, an energy source may include an energy source characteristic data file stored in, for example, a memory integral in the respective energy source. When the energy source is connected to the energy conversion device 305, processor 322 may automatically receive the energy source characteristic data file, and the processor 322 may automatically configure the energy conversion device 305 to incorporate the energy source based on the energy source characteristic data.

The processor 322 may execute an input specification module 425a to, for example, cause the processor 322 to receive input specification data (block 415b). The input specification data may be representative of, for example, energy source output and/or energy conversion device 305 inputs (e.g., voltage ratings, current ratings, frequency ratings, storage capacity, etc.).

The processor 322 may execute an energy source deletion module 430a to, for example, cause the processor 322 to automatically delete an energy source from the energy conversion device 305 (block 420b). Alternatively, or additionally, a user may manually delete an energy source via the user interface described with regard to block 405b.

The processor 322 may execute a load addition module 435a to, for example, cause the processor 322 to automatically add an energy load when the energy load is connected to the energy conversion device 305 (block 425b). Thereby, an energy conversion device 305 may automatically incorporate a newly connected energy load in accordance with a “plug-and-play” architecture. For example, an energy load may include an energy load characteristic data file stored in, for example, a memory integral in the respective energy load. When the energy load is connected to the energy conversion device 305, processor 322 may automatically receive the energy load characteristic data file, and the processor 322 may automatically configure the energy conversion device 305 to incorporate the energy load based on the energy load characteristic data.

The processor 322 may execute a load deletion module 440a to, for example, cause the processor to automatically delete an energy load from the energy conversion device 305 (block 430b). Alternatively, or additionally, a user may manually delete an energy load via the user interface described with regard to block 405b.

The processor 322 may execute an output specification module 445a to, for example, cause the processor 322 to receive load specification data (block 435b). The load specification data may be representative of, for example, energy load input and/or energy conversion device 305 outputs (e.g., voltage ratings, current ratings, frequency ratings, etc.).

As described above, the method 400b may comprise a program (or module) for execution by an energy apparatus processor 322. The program (or module) may be embodied in software stored on a tangible (or non-transitory) computer readable storage medium such as a compact disc read-only memory (“CD-ROM”), a floppy disk, a hard drive, a DVD, Blu-ray disk, or a memory associated with the PED processor. Alternatively, the entire program (or module) and/or parts thereof may be executed by a device other than the energy apparatus processor 322 and/or embodied in firmware or dedicated hardware (e.g., one or more discrete component circuits, one or more application specific integrated circuits (ASICs), etc.). Further, although the example program (or module) is described with reference to the flowchart illustrated in FIG. 4B, many other methods of implementing the method 400b may alternatively be used. For example, the order of execution of the blocks may be changed, and/or some of the blocks described may be changed, eliminated, or combined.

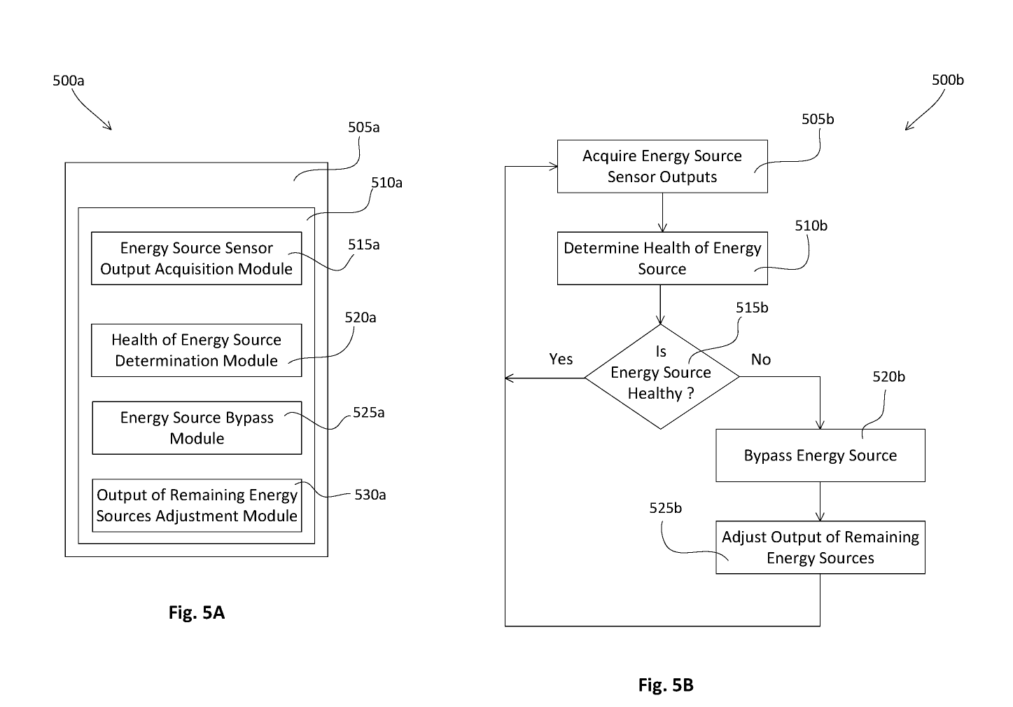

With reference to FIG. 5A, an apparatus 500a for managing an energy device 505a may include an energy source sensor output acquisition module 515a, a health of energy source determination module 520a, an energy source bypass module 525a, and an output of remaining energy sources adjustment module 530a stored on a memory 510a. The apparatus 505a may be similar to, for example, the workstation 319 of FIG. 3. The energy device 500a may be similar to, for example, the energy conversion device 305 of FIG. 3.

While the energy source sensor output acquisition module 515a, the health of energy source determination module 520a, the energy source bypass module 525a, or the output of remaining energy sources adjustment module 530a may be stored on the non-transitory computer-readable medium 510a in the form of computer-readable instructions, any one of, all of, or any sub-combination of the energy source sensor output acquisition module 515a, the health of energy source determination module 520a, the energy source bypass module 525a, or the output of remaining energy sources adjustment module 530a may be implemented by hardware (e.g., one or more discrete component circuits, one or more application specific integrated circuits (ASICs), etc.), firmware (e.g., one or more programmable application specific integrated circuits (ASICs), one or more programmable logic devices (PLDs), one or more field programmable logic devices (FPLD), one or more field programmable gate arrays (FPGAs), etc.), and/or any combination of hardware, software and/or firmware. Furthermore, the apparatus 505a of FIG. 5A may include one or more elements, processes and/or devices in addition to, or instead of, those illustrated in FIG. 5A, and/or may include more than one of, any, or all of the illustrated elements, processes and devices.

Turning to FIG. 5B, a method for managing an energy apparatus 500b may be implemented by, for example, a processor (e.g., processor 322 of FIG. 3) executing a module (e.g., module 324 of FIG. 3, or modules 515a-530a of FIG. 5A). In any event, the processor 322 may execute an energy source sensor output acquisition module 515a to, for example, cause the processor 322 to receive energy source sensor output data from a sensor (e.g., sensor 260 of FIG. 2, or sensor 315 of FIG. 3) (block 505b). The energy source sensor output data may be representative of, for example, energy source output connections and/or characteristics (e.g., energy source primary energy input, energy source output voltage, energy source output current, energy source frequency, energy source pressure, energy source storage capacity, energy source stored energy, etc.).

The processor 322 may execute a health of energy source determination module 520a to, for example, cause the processor 322 to determine a health of an energy source based on, for example, the energy source sensor output data (block 510b). For example, the processor 322 may receive sensor data associated with a solar panel (e.g., incident light data and output voltage data) and the processor 322 may determine whether the solar panel, or a connection to the solar panel, is malfunctioning based on the sensor data.

The processor 322 may execute an energy source bypass module 525a to, for example, cause the processor 322 to bypass an energy source (block 520b) when, for example, the processor 322 determines that the energy source is not healthy (block 515b). If the processor 322 determines that the energy source is healthy (block 515b), the processor may return to block 505b.

The processor 322 may execute an output of remaining energy sources adjustment module 530a to, for example, cause the processor 322 to adjust outputs of remaining energy source(s) (block 525b). For example, if the processor 322 bypasses an unhealthy energy source (block 520b), the processor 322 may adjust output of at least one remaining, healthy, energy source to account for the energy source that was bypassed.

As described above, the method 500b may comprise a program (or module) for execution by an energy apparatus processor 322. The program (or module) may be embodied in software stored on a tangible (or non-transitory) computer readable storage medium such as a compact disc read-only memory (“CD-ROM”), a floppy disk, a hard drive, a DVD, Blu-ray disk, or a memory associated with the PED processor. Alternatively, the entire program (or module) and/or parts thereof may be executed by a device other than the energy apparatus processor 322 and/or embodied in firmware or dedicated hardware (e.g., one or more discrete component circuits, one or more application specific integrated circuits (ASICs), etc.). Further, although the example program (or module) is described with reference to the flowchart illustrated in FIG. 5B, many other methods of implementing the method 500b may alternatively be used. For example, the order of execution of the blocks may be changed, and/or some of the blocks described may be changed, eliminated, or combined.

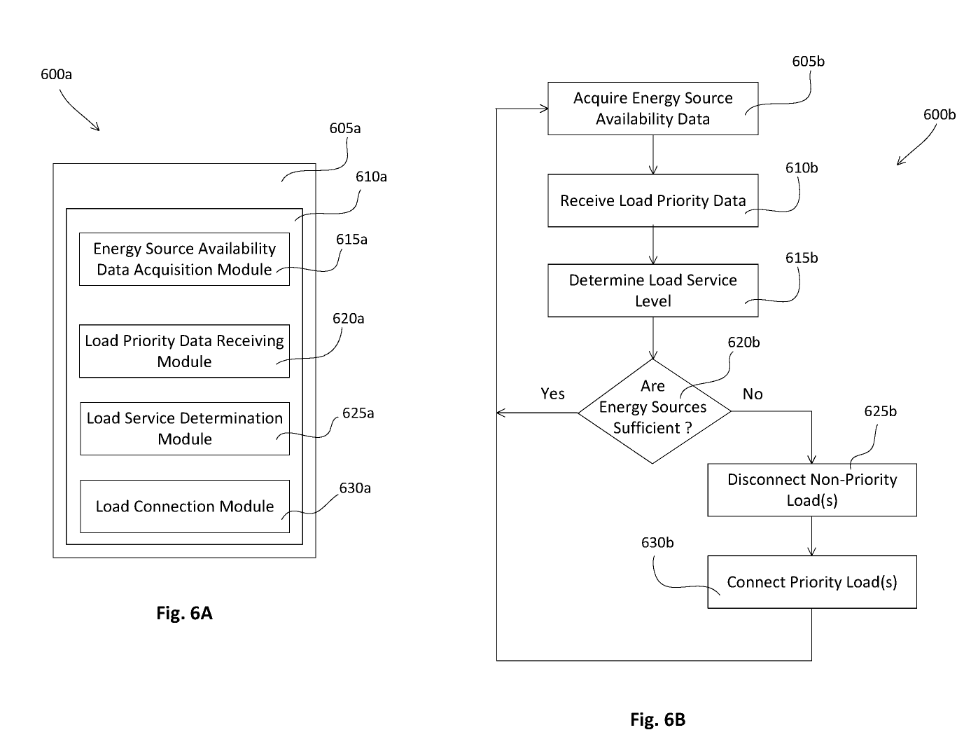

With reference to FIG. 6A, an apparatus 605a for managing an energy system 600a may include an energy source availability data acquisition module 615a, a load priority data receiving module 620a, a load service determination module 625a, and a load connection module 630a stored on a memory 510a. The apparatus 605a may be similar to, for example, the first or second workstations 112, 119 of FIG. 1, the workstation 219 of FIG. 2, or the workstation 319 of FIG. 3. The energy system 600a may be similar to, for example, the energy system 100 of FIG. 1, the energy system 200 of FIG. 2 or the energy system 300 of FIG. 3.

While the energy source availability data acquisition module 615a, the load priority data receiving module 620a, the load service determination module 625a, or the load connection module 630a may be stored on the non-transitory computer-readable medium 610a in the form of computer-readable instructions, any one of, all of, or any sub-combination of the energy source availability data acquisition module 615a, the load priority data receiving module 620a, the load service determination module 625a, or the load connection module 630a may be implemented by hardware (e.g., one or more discrete component circuits, one or more application specific integrated circuits (ASICs), etc.), firmware (e.g., one or more programmable application specific integrated circuits (ASICs), one or more programmable logic devices (PLDs), one or more field programmable logic devices (FPLD), one or more field programmable gate arrays (FPGAs), etc.), and/or any combination of hardware, software and/or firmware. Furthermore, the apparatus 605a of FIG. 6A may include one or more elements, processes and/or devices in addition to, or instead of, those illustrated in FIG. 6A, and/or may include more than one of, any, or all of the illustrated elements, processes and devices.

Turning to FIG. 6B, a method for managing an energy system 600b may be implemented by, for example, a processor (e.g., processor 115 of FIG. 1) executing a module (e.g., module 117 of FIG. 1, or modules 615a-630a of FIG. 6A). In any event, the processor 115 may execute an energy source availability data acquisition module 615a to, for example, cause the processor 115 to acquire energy source availability data (block 605b). The energy source availability data may be, for example, representative of whether, or not, a particular energy source is available. The energy source availability data may be received from, for example, an energy source disconnect (e.g., disconnect 135, 150, 165 of FIG. 1) and/or an sensor (e.g., sensor 260 of FIG. 2, or sensor 315 of FIG. 3).

The processor 115 may execute a load priority data receiving module 620a to, for example, cause the processor 115 to receive load priority data (block 610b). The load priority data may be representative of a pre-defined priority of connected energy loads. For example, a residential energy load may include a heating ventilating and air conditioning system load, a light load, a water heater load, a television load, etc. The load priority data may indicate which load(s) will be disconnected in an event that not enough energy is available from available energy sources.

The processor 115 may execute a load service determination module 625a to, for example, cause the processor 115 to determine which load(s) to serve (block 615b). For example, the processor 115 may determine which load(s) to serve based on the energy source availability data and the load priority data.

The processor 115 may execute a load connection module 630a to, for example, cause the processor 115 to automatically disconnect non-priority load(s) (block 625b) connect priority energy load(s) (block 630b). For example, the processor may automatically disconnect non-priority load(s) (block 625b) connect priority energy load(s) (block 630b) based on whether the processor 115 determines whether available energy sources are sufficient (block 620b).

As a particular example, if the processor 115 determines that a heater load has a highest priority, and the processor 115 determines that only enough energy is available to serve the heater load, the processor 115 may automatically cause all other loads to be disconnected.

As described above, the method 600b may comprise a program (or module) for execution by an energy apparatus processor 115. The program (or module) may be embodied in software stored on a tangible (or non-transitory) computer readable storage medium such as a compact disc read-only memory (“CD-ROM”), a floppy disk, a hard drive, a DVD, Blu-ray disk, or a memory associated with the PED processor. Alternatively, the entire program (or module) and/or parts thereof may be executed by a device other than the energy apparatus processor 115 and/or embodied in firmware or dedicated hardware (e.g., one or more discrete component circuits, one or more application specific integrated circuits (ASICs), etc.). Further, although the example program (or module) is described with reference to the flowchart illustrated in FIG. 6B, many other methods of implementing the method 600b may alternatively be used. For example, the order of execution of the blocks may be changed, and/or some of the blocks described may be changed, eliminated, or combined.

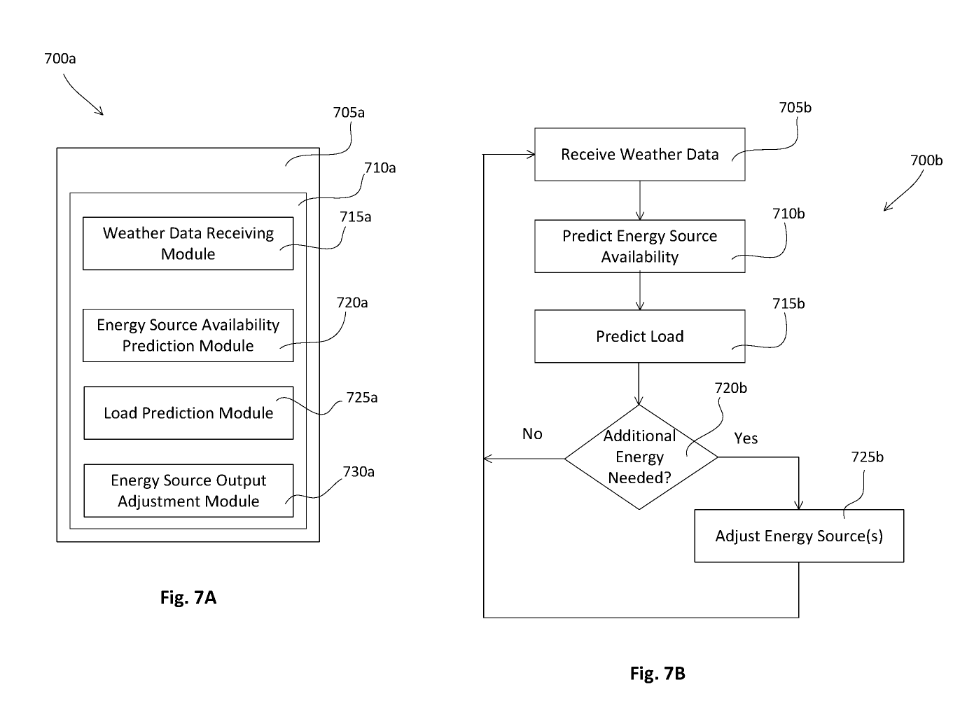

With reference to FIG. 7A, an apparatus 705a for managing an energy system 700a may include a weather data receiving module 715a, an energy source availability prediction module 720b, a load prediction module 725b, and an energy source output adjustment module 730a stored on a memory 510a. The apparatus 605a may be similar to, for example, the first or second workstations 112, 119 of FIG. 1, the workstation 219 of FIG. 2, or the workstation 319 of FIG. 3. The energy system 600a may be similar to, for example, the energy system 100 of FIG. 1, the energy system 200 of FIG. 2 or the energy system 300 of FIG. 3.

While the weather data receiving module 715a, the energy source availability prediction module 720b, the load prediction module 725b, or the energy source output adjustment module 730a may be stored on the non-transitory computer-readable medium 610a in the form of computer-readable instructions, any one of, all of, or any sub-combination of the weather data receiving module 715a, the energy source availability prediction module 720b, the load prediction module 725b, or the energy source output adjustment module 730a may be implemented by hardware (e.g., one or more discrete component circuits, one or more application specific integrated circuits (ASICs), etc.), firmware (e.g., one or more programmable application specific integrated circuits (ASICs), one or more programmable logic devices (PLDs), one or more field programmable logic devices (FPLD), one or more field programmable gate arrays (FPGAs), etc.), and/or any combination of hardware, software and/or firmware. Furthermore, the apparatus 705a of FIG. 7A may include one or more elements, processes and/or devices in addition to, or instead of, those illustrated in FIG. 7A, and/or may include more than one of, any, or all of the illustrated elements, processes and devices.

Turning to FIG. 7B, a method for managing an energy system 700b may be implemented by, for example, a processor (e.g., processor 115 of FIG. 1) executing a module (e.g., module 117 of FIG. 1, or modules 715a-730a of FIG. 7A). In any event, the processor 115 may execute a weather data receiving module 715a to, for example, cause the processor 115 to receive weather data (block 705b). The weather data may be, for example, representative of an actual temperature, a predicted temperature, historical temperature for a given day of a year and time of the day, actual wind, predicted wind, historical wind for a given day of a year and time of the day, actual precipitation, predicted precipitation, historical precipitation for a given day of a year and time of the day, actual cloud/sun, predicted cloud/sun, historical cloud/sun for a given day of a year and time of the day, actual humidity, predicted humidity, historical humidity for a given day of a year and time of the day, actual parametric pressure, predicted parametric pressure, historical parametric pressure for a given day of a year and time of the time, actual UV index, a predicted UV index, historical UV index for a particular day of a year and time of the day, an impending earthquake, etc.

The processor 115 may execute an energy source availability prediction module 720b to, for example, cause the processor 115 to predict availability of an energy source (block 710b). For example, the processor 115 may predict availability of an energy source based on the weather data. As a particular example, the processor 115 may predict availability of energy from a solar panel based on actual cloud/sun data, predicted cloud/sun data, historical cloud/sun data for a particular day of a year and time of the day, or any combination thereof. As another example, the processor 115 may predict availability of energy from a wind turbine based on actual wind data, predicted wind data, historical wind data for a particular day of a year and time of the day, or any combination thereof.

The processor 115 may execute a load prediction module 725b to, for example, cause the processor 115 to predict an energy load (block 715b). For example, the processor 115 may predict an energy load based on the weather data.

The processor 115 may execute an energy source output adjustment module 730a to, for example, cause the processor 115 to adjust an output of at least one energy source (block 720b). For example, the processor 115 may automatically adjust an output of an energy source (block 720b) based on whether the processor 115 determines that additional energy is needed (block 720b). As a particular example, the processor 115 may automatically adjust an amount of energy to be stored in an energy storage device based on predicted weather. Thereby, the processor 115 may automatically adjust outputs of various energy sources prior to an actual change in weather that would require an adjustment in the future. Predicting future energy source availability and energy loads may increase energy system reliability, reduce energy system costs, avoid energy system outages, avoid energy system overloads, etc.

As described above, the method 700b may comprise a program (or module) for execution by an energy apparatus processor 115. The program (or module) may be embodied in software stored on a tangible (or non-transitory) computer readable storage medium such as a compact disc read-only memory (“CD-ROM”), a floppy disk, a hard drive, a DVD, Blu-ray disk, or a memory associated with the PED processor. Alternatively, the entire program (or module) and/or parts thereof may be executed by a device other than the energy apparatus processor 115 and/or embodied in firmware or dedicated hardware (e.g., one or more discrete component circuits, one or more application specific integrated circuits (ASICs), etc.). Further, although the example program (or module) is described with reference to the flowchart illustrated in FIG. 7B, many other methods of implementing the method 700b may alternatively be used. For example, the order of execution of the blocks may be changed, and/or some of the blocks described may be changed, eliminated, or combined.

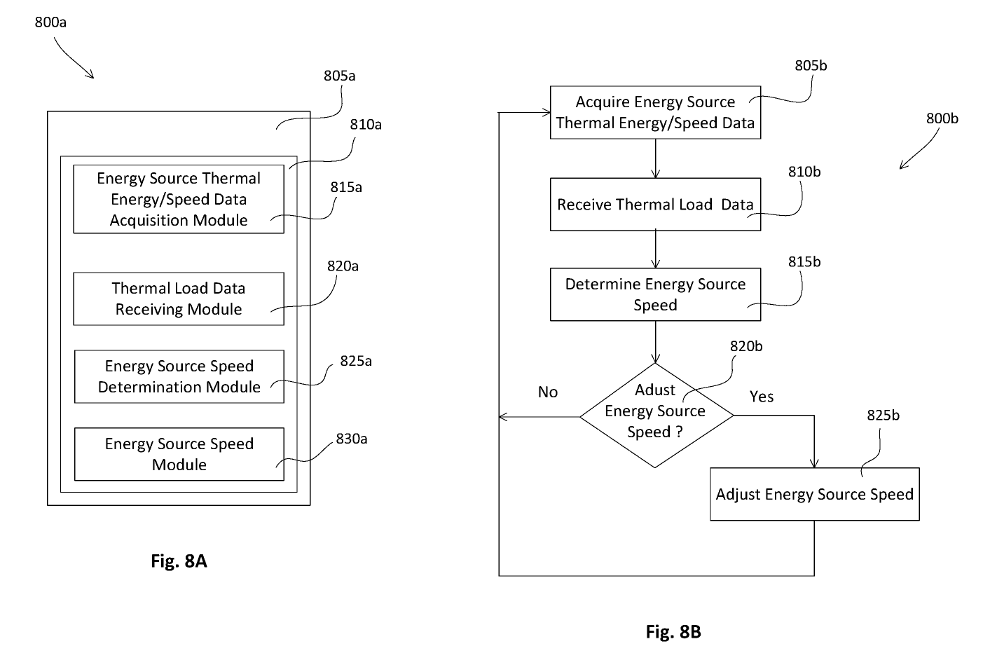

With reference to FIG. 8A, an apparatus 800a for managing an energy device 805a may include an energy source thermal energy/speed data acquisition module 815a, a thermal load data receiving module 820a, an energy source speed determination module 825a, and an energy source speed module 830a stored on a memory 510a. The apparatus 505a may be similar to, for example, the workstation 319 of FIG. 3. The energy device 500a may be similar to, for example, the energy conversion device 305 of FIG. 3.

While the energy source thermal energy/speed data acquisition module 815a, the thermal load data receiving module 820a, the energy source speed determination module 825a, or the energy source speed module 830a may be stored on the non-transitory computer-readable medium 810a in the form of computer-readable instructions, any one of, all of, or any sub-combination of the energy source thermal energy/speed data acquisition module 815a, the thermal load data receiving module 820a, the energy source speed determination module 825a, or the energy source speed module 830a may be implemented by hardware (e.g., one or more discrete component circuits, one or more application specific integrated circuits (ASICs), etc.), firmware (e.g., one or more programmable application specific integrated circuits (ASICs), one or more programmable logic devices (PLDs), one or more field programmable logic devices (FPLD), one or more field programmable gate arrays (FPGAs), etc.), and/or any combination of hardware, software and/or firmware. Furthermore, the apparatus 805a of FIG. 8A may include one or more elements, processes and/or devices in addition to, or instead of, those illustrated in FIG. 8A, and/or may include more than one of, any, or all of the illustrated elements, processes and devices.

Turning to FIG. 8B, a method for managing an energy apparatus 800b may be implemented by, for example, a processor (e.g., processor 322 of FIG. 3) executing a module (e.g., module 324 of FIG. 3, or modules 815a-830a of FIG. 8A). In any event, the processor 322 may execute an energy source thermal energy/speed data acquisition module 815a to, for example, cause the processor 322 to acquire energy source thermal energy/speed data (block 805b). The energy source thermal energy/speed data may be, for example, representative of relationship between a speed of rotation of a secondary energy source and an amount of thermal energy produced by the secondary energy source. Alternatively, or additionally, the energy source thermal energy/speed data may be representative of a relationship between an amount of electrical energy produced by an energy source and an amount of thermal energy produced by the energy source.

The processor 322 may execute a thermal load data receiving module 820a to, for example, cause the processor 322 to receive thermal load data (block 810b). The thermal load data may be representative of an amount of thermal energy required by a particular energy load. For example, the thermal energy data may be derived from a sensor (e.g., sensor 260 of FIG. 2, or sensor 315 of FIG. 3). In a particular example, the sensor 260, 315 may be a thermostat.

The processor 322 may execute an energy source speed determination module 825a to, for example, to cause the processor 322 to determine a speed of an energy source (block 815b). For example, the processor 322 may determine a speed of a secondary energy source based on energy source thermal energy/speed data and/or thermal load data. The thermal energy may be generated from an exhaust of a prime mover (e.g., an exhaust of an internal combustion engine, an exhaust of a turbine, etc.) and/or from burning a primary energy source. In any event, a heat duct (e.g., a plenum, ductwork, etc.) may be configured to convey the thermal energy to an associated thermal load via, for example, either convection and/or forced air.

The processor 322 may execute an energy source speed module 830a to, for example, cause the processor 322 to adjust a speed of an energy source (block 825b). For example, the processor 322 may adjust a speed of an energy source (block 825b) based on whether the processor 322 determines that a speed of an energy source needs to be adjusted (block 520b). In a particular example, the processor 322 may adjust a speed of an electrical generator based on whether a thermostat output is indicative of a thermal load requiring more heat (e.g., a house requiring more heat). Any excess electricity may be stored in an associated energy storage device and/or may be used to generate additional heat via, for example, a resistive heater or a electrically driven heat pump.

As described above, the method 800b may comprise a program (or module) for execution by an energy apparatus processor 322. The program (or module) may be embodied in software stored on a tangible (or non-transitory) computer readable storage medium such as a compact disc read-only memory (“CD-ROM”), a floppy disk, a hard drive, a DVD, Blu-ray disk, or a memory associated with the PED processor. Alternatively, the entire program (or module) and/or parts thereof may be executed by a device other than the energy apparatus processor 322 and/or embodied in firmware or dedicated hardware (e.g., one or more discrete component circuits, one or more application specific integrated circuits (ASICs), etc.). Further, although the example program (or module) is described with reference to the flowchart illustrated in FIG. 8B, many other methods of implementing the method 800b may alternatively be used. For example, the order of execution of the blocks may be changed, and/or some of the blocks described may be changed, eliminated, or combined.

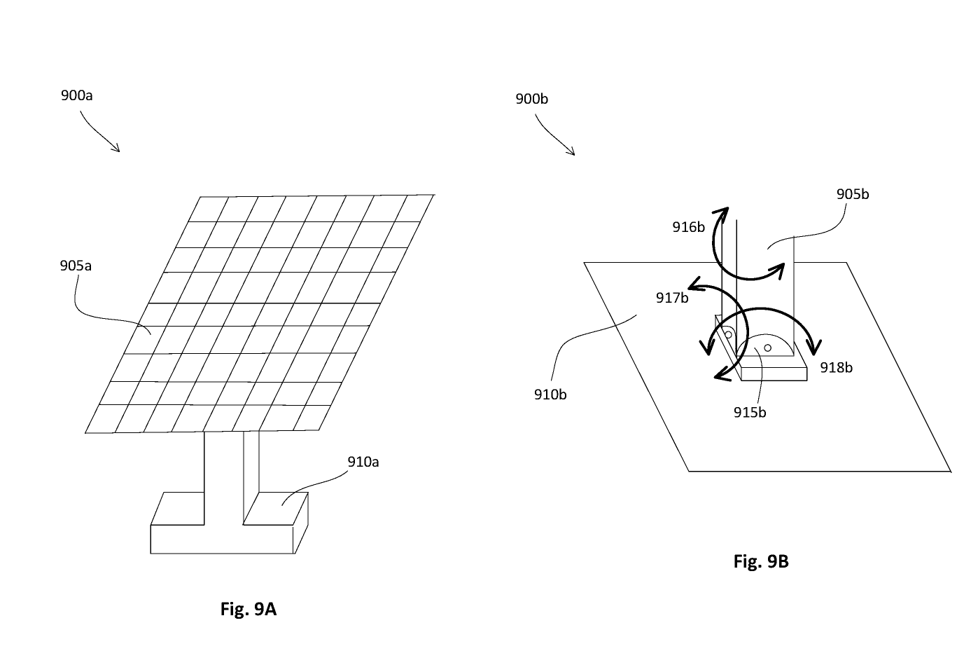

With reference to FIGS. 9A and 9B, an energy apparatus 900a, 900b may include at least one solar panel 905a, 905b reorientably attached to a mount 910a, 910b via a pivot mechanism 915b. As illustrated in FIG. 9B, the solar panel 905a, 905b may rotate 916b, may tilt 917b, and/or may pan 918b about the pivot mechanism 915b. The pivot mechanism may include an actuating mechanism such that the solar panel 905a, 905b may be automatically reoriented via an associated control apparatus (e.g., first or second workstations 112, 119 of FIG. 1, workstation 219 of FIG. 2, or workstation 319 of FIG. 3). The energy apparatus 900a, 900b may be, for example, as described in U.S. patent application Ser. No. 14/880,578, entitled SOLAR PANEL SYSTEM WITH MONOCOQUE SUPPORTING STRUCTURE, filed Oct. 12, 2015, the disclosure of which is incorporated in its entirety herein by reference thereto.

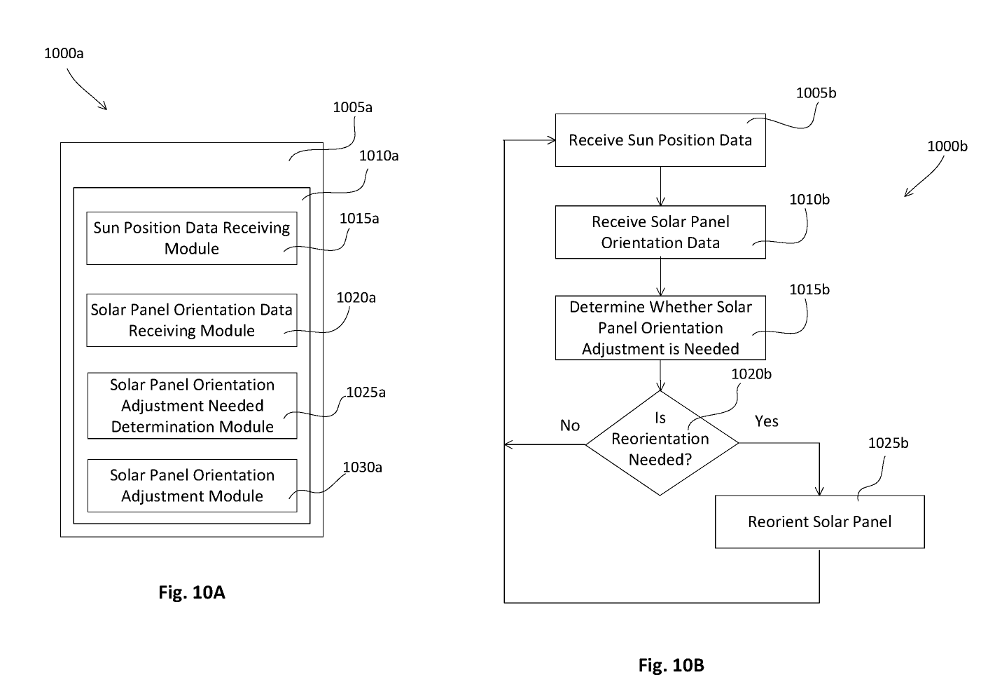

Turning to FIG. 10A, an apparatus 1005a for managing an energy device 1000a may include a sun position data receiving module 1015a, a solar panel orientation data receiving module 1020a, a solar panel orientation adjustment needed determination module 1025a, and a solar panel orientation adjustment module 1030a stored on a memory 510a. The apparatus 605a may be similar to, for example, the first or second workstations 112, 119 of FIG. 1, the workstation 219 of FIG. 2, or the workstation 319 of FIG. 3. The energy system 600a may be similar to, for example, the energy system 100 of FIG. 1, the energy system 200 of FIG. 2 or the energy system 300 of FIG. 3.

While the sun position data receiving module 1015a, the solar panel orientation data receiving module 1020a, the solar panel orientation adjustment needed determination module 1025a, or the solar panel orientation adjustment module 1030a may be stored on the non-transitory computer-readable medium 1010a in the form of computer-readable instructions, any one of, all of, or any sub-combination of the sun position data receiving module 1015a, the solar panel orientation data receiving module 1020a, the solar panel orientation adjustment needed determination module 1025a, or the solar panel orientation adjustment module 1030a may be implemented by hardware (e.g., one or more discrete component circuits, one or more application specific integrated circuits (ASICs), etc.), firmware (e.g., one or more programmable application specific integrated circuits (ASICs), one or more programmable logic devices (PLDs), one or more field programmable logic devices (FPLD), one or more field programmable gate arrays (FPGAs), etc.), and/or any combination of hardware, software and/or firmware. Furthermore, the apparatus 1005a of FIG. 10A may include one or more elements, processes and/or devices in addition to, or instead of, those illustrated in FIG. 10A, and/or may include more than one of, any, or all of the illustrated elements, processes and devices.

With reference to FIG. 10B, a method for managing an energy apparatus 1000b may be implemented by, for example, a processor (e.g., processor 115 of FIG. 1) executing a module (e.g., module 117 of FIG. 1, or modules 1015a-1030a of FIG. 10A). In any event, the processor 115 may execute a sun position data receiving module 1015a to, for example, cause the processor 115 to receive sun position data (block 1005b). While the sun position data may be representative of a current position of the sun relative to an associated solar panel (e.g., solar panel 905a, 905b of FIGS. 9A and 9B), the sun position data may, alternatively, be representative of a position of a highest concentration of solar energy radiating from the sun. For example, while the sun may be located in a particular position, clouds may be blocking a portion of the solar energy radiating from the sun, thus, the sun position data may be representative of a position having less cloud cover. Similarly, the actual position of the sun may be in a location that produces both direct radiation and reflected radiation (e.g., reflected radiation from water, reflected radiation from mirrors, reflected radiation from snow, reflection from a pond, reflected radiation from other structures, etc.), accordingly, the sun position data may be representative of a location that experiences a maximum of direct radiation plus reflected radiation. The processor 115 may receive the sun position data from, for example, a sensor (e.g., sensor 260 of FIG. 2 or sensor 315 of FIG. 3).

The processor 115 may execute a solar panel orientation data receiving module 1020a to, for example, cause the processor to receive solar panel orientation data (block 1010b). The solar orientation data may be, for example, representative of an orientation of at least one solar panel relative to the sun position data. The processor 115 may receive the solar panel orientation data from, for example, a sensor (e.g., sensor 260 of FIG. 2 or sensor 315 of FIG. 3) incorporated into, for example, a pivot mechanism (e.g., pivot mechanism 915b of FIG. 9B).

The processor 115 may execute a solar panel orientation adjustment needed determination module 1025a to, for example, cause the processor to determine whether solar panel orientation adjustment is needed (block 1015b). For example, the processor 115 may determine whether solar panel orientation adjustment is needed based on the sun position data and the solar panel orientation data (block 1020b).

The processor 115 may execute a solar panel orientation adjustment module 1030a to, for example, cause the processor to automatically adjust an orientation of at least one solar panel (block 1025b). For example, the processor 115 may automatically transmit a control signal to a pivot mechanism (e.g., pivot mechanism 915b of FIG. 9B) in response to determining that at least one solar panel orientation adjustment is needed based on the sun position data and the solar panel orientation data (block 1020b).

As described above, the method 1000b may comprise a program (or module) for execution by an energy apparatus processor 115. The program (or module) may be embodied in software stored on a tangible (or non-transitory) computer readable storage medium such as a compact disc read-only memory (“CD-ROM”), a floppy disk, a hard drive, a DVD, Blu-ray disk, or a memory associated with the PED processor. Alternatively, the entire program (or module) and/or parts thereof may be executed by a device other than the energy apparatus processor 115 and/or embodied in firmware or dedicated hardware (e.g., one or more discrete component circuits, one or more application specific integrated circuits (ASICs), etc.). Further, although the example program (or module) is described with reference to the flowchart illustrated in FIG. 10B, many other methods of implementing the method 1000b may alternatively be used. For example, the order of execution of the blocks may be changed, and/or some of the blocks described may be changed, eliminated, or combined.

Numerous modifications to the apparatuses, systems, and methods disclosed herein will be apparent to those skilled in the art in view of the foregoing description. Accordingly, this description is to be construed as illustrative only, and is presented for the purpose of enabling those skilled in the art to make and use the invention and to teach the preferred mode of carrying out same. The exclusive rights to all modifications within the scope of the disclosure and the appended claims are reserved.

What is claimed is:

1. An energy conversion apparatus, comprising:
at least one first reconfigurable energy source input, wherein the at least one first reconfigurable energy source input is reconfigurable based upon first energy source characteristic data received by the energy conversion apparatus;
at least one second reconfigurable energy source input, wherein the at least one second reconfigurable energy source input is reconfigurable based upon second energy source characteristic data received by the energy conversion apparatus;
at least one energy storage device connection; and
at least one energy load output, wherein the energy conversion apparatus is configured to provide energy to the at least one energy load output based upon the first and second energy source characteristic data, and further based on a quantity of energy stored in at least one energy storage device.

2. The energy conversion apparatus as in claim 1, wherein the at least one energy storage device connection is reconfigurable based upon energy storage device characteristic data received by the energy conversion apparatus.

3. The energy conversion apparatus as in claim 1, wherein the at least one energy load output is reconfigurable based upon energy load characteristic data received by the energy conversion apparatus.

4. The energy conversion apparatus as in claim 1, wherein at least one of: the first energy source characteristic data, or the second energy source characteristic data is automatically received by the energy conversion apparatus when a respective energy source is connected to the energy conversion apparatus.

5. The energy conversion apparatus as in claim 1, further comprising:
a user interface device, wherein at least one of: the first energy source characteristic data, or the second energy source characteristic data is received by the energy conversion apparatus via the user interface device.

6. The energy conversion apparatus as in claim 1, further comprising:
an energy conversion device, wherein the energy conversion device is configured to perform at least one of: rectify alternating electric current to direct electric current, invert direct electric current to alternating electric current, or convert a first direct electric current source value to a second direct current source value.

7. The energy conversion apparatus of claim 6, wherein the energy conversion device is bidirectional.

8. The energy conversion apparatus of claim 1, wherein the energy conversion apparatus automatically receives weather data, and wherein the energy conversion device automatically determines an amount of energy to provide to the at least one energy load connection from the first energy source input and the second energy source input based on the weather data.

9. The energy conversion apparatus of claim 1, wherein the energy conversion apparatus automatically receives energy source health data, and wherein the energy conversion device automatically determines an amount of energy to provide to the at least one energy load connection from the first energy source input and the second energy source input based on the energy source health data.

10. The energy conversion apparatus of claim 1, further comprising:
at least one second energy load output, wherein the energy conversion device automatically receives energy load priority data, and wherein the energy conversion device determines energy flow to a respective energy load based upon the energy load priority data.

11. An energy management system, comprising:
at least one energy conversion apparatus having at least two energy source inputs, at least one energy storage device connection, and at least one energy load output; and
a controller having at least one energy source health data input and at least one energy conversion apparatus output, wherein the controller generates the at least one energy conversion apparatus output based upon energy source health data received via the at least one energy source health data input.

12. The energy management system as in claim 11, wherein the energy source health data is representative of at least one of: a health of at least one energy source, a health of at least one connection to at least one energy source, or availability of a primary energy source to at least one secondary energy source.

13. The energy management system of claim 11, wherein the energy source health data includes weather data that is representative of at least one of: a solar radiation value, or a wind speed value.

14. The energy system of claim 11, wherein the controller automatically receives energy storage device health data, and wherein the controller automatically determines an amount of energy to provide to the at least one energy load connection from the first energy source input and the second energy source input based on the energy storage device health data.

15. The energy conversion apparatus of claim 11, further comprising:
at least one second energy load output, wherein the controller automatically receives energy load priority data, and wherein the controller determines energy flow to a respective energy load based upon the energy load priority data.

16. An energy management system, comprising:
at least one energy conversion apparatus having at least one energy source input, at least one energy storage device connection, and at least two energy load outputs; and
a controller having at least one energy load priority data input and at least one energy conversion apparatus output, wherein the controller generates the at least one energy conversion apparatus output based upon energy load priority data received via the at least one energy load priority data input.

17. The energy conversion apparatus of claim 16, wherein the controller automatically receives energy source health data, and wherein the controller determines energy flow based upon the energy source health data.

18. The energy management system as in claim 17, wherein the energy source health data is representative of at least one of: a health of at least one energy source, a health of at least one connection to at least one energy source, or availability of a primary energy source to at least one secondary energy source.

19. The energy management system of claim 17, wherein the energy source health data includes weather data that is representative of at least one of: a solar radiation value, or a wind speed value.

20. The energy system of claim 17, wherein the controller automatically receives energy storage device health data, and wherein the controller automatically determines an amount of energy to provide to at least one energy load connection from the energy source input and the energy device connection based on the energy storage device health data.
